(19) United States
(12) Patent Application Publication
(10) Pub. No.: US 2026/0313410 A1
(43) Pub. Date: Oct. 8, 2026

(54) Automated Layer Switch-Off

(71) Applicant: Parallel Wireless, Inc., Nashua, NH (US)

(72) Inventor: Koby Shimonovich, Kfar Saba (IL)

(21) Appl. No.: 19/535,780

(22) Filed: Feb. 10, 2026

Related U.S. Application Data
(60) Provisional application No. 63/756,047, filed on Feb. 7, 2025.

(51) Int. Cl. H04W 24/08; H04W 48/06; H04W 76/30; H04W 88/08; H04W 88/12

(52) U.S. Cl. CPC H04W 24/08; H04W 48/06; H04W 76/30; H04W 88/085; H04W 88/12

(57) ABSTRACT

Methods and systems for cellular radio management are disclosed. In a first embodiment, a method is disclosed for managing layers in a radio access network node, comprising: a. Collecting activity measurements from cells in both the capacity and coverage layers; b. Determining to disable the capacity layer in a particular cell when predefined conditions based on the activity measurements fall below a threshold; c. Redirecting any remaining user equipment (UE) to the coverage layer before shutting down the capacity layer in the cell; d. Continuously monitoring activity measurements from cells in the coverage layer to determine when the capacity layer needs to be re-enabled.

### CROSS-REFERENCE TO RELATED APPLICATIONS

This application is a non-provisional conversion of, and claims priority under 35 U.S.C. § 119(e) to, U.S. Provisional Patent Application No. 63/756,047, filed Feb. 7, 2025 and having the same title as the present application, which is hereby incorporated by reference in its entirety. In addition, this application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; US20170257133A1; US20230269633A1; and US20200128414A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. Pat. App. No. Ser. No. 14/510,074, “Parameter Optimization and Event Prediction Based on Cell Heuristics,” filed Oct. 8, 2014, U.S. patent application Ser. No. 14/642,544, “Federated X 2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01,71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828427, U.S. Pat. App. Pub. Nos. US20170273134A1, US20170127409A1, US20200128414A1, US20230019380A1 in their entirety. Features and characteristics of and pertaining to the systems and methods described in the present disclosure, including details of the multi-RAT nodes and the gateway described herein, are provided in the documents incorporated by reference.

### BACKGROUND

Open Radio Access Network (Open RAN) is a movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs).

There is a need for energy saving in cellular networking today. Energy efficiency is one of the primary concerns for mobile network operators (MNOs) today. With 5G densification, which is the increasing number of cells needed to deliver good 5G service, the need to be aware of energy consumption has gone from being a “social nicety” to an OPEX imperative. Also, within the mobile network, RANs consume a significant amount of energy, indeed perhaps the greatest energy consumption within the mobile network, and as data usage continues to rise so too will the power consumption of the RAN. In fact, according to some sources, the global use of energy by cellular RANs is ~1.5% of global electric consumption.

### SUMMARY

In a first embodiment, a method is disclosed for managing layers in a radio access network node, comprising: a. Collecting activity measurements from cells in both the capacity and coverage layers; b. Determining to disable the capacity layer in a particular cell when predefined conditions based on the activity measurements fall below a threshold; c. Redirecting any remaining user equipment (UE) to the coverage layer before shutting down the capacity layer in the cell; d. Continuously monitoring activity measurements from cells in the coverage layer to determine when the capacity layer needs to be re-enabled.

### BRIEF DESCRIPTION OF THE DRAWINGS

FIG. 1 is a logic flow diagram of layer shutdown, in accordance with some embodiments.

FIG. 2 is a logic flow diagram of layer reactivation, in accordance with some embodiments.

FIG. 3 is a schematic diagram of an Open RAN 4G/5G deployment architecture, in accordance with some embodiments.

FIG. 4 is a schematic diagram of a multi-RAT RAN deployment architecture, in accordance with some embodiments.

FIG. 5 illustrates a block diagram of a layer shutoff coordination system 500 for managing layers in a radio access network.

FIG. 6 illustrates a block diagram of an Energy Saving Layer Shutdown System 600.

### DETAILED DESCRIPTION

Within an O-RAN-based network architecture, according to the O-RAN Alliance, see figure below, the Near-RT RIC provides an ideal location from which to oversee energy saving operations. Via the E2 interface and the associated service models, it has near real time visibility of metrics from across the RAN, allowing it to formulate decisions based on multiple inputs and generate the associated RAN control signals. Additionally, the Near-RT RIC is connected to the Non-RT RIC over the A1 interface, from which it can be configured with operational policies. These policies can, in turn, potentially be informed through the application of AI/ML approaches within the RIC-for example, a policy might be formulated by learning the expected temporal distribution of users within a cluster of cells and predicting key times at which to deploy certain ES measures.

The current scope of energy saving functionality in the prior art is 4G cell shutdown and restore at times of low cell load demand. Shutting down the cell is typically realized by moving to Admin Down state which will suspend the cell operation in the vNode/PhyNode, saving energy in the VBBU, and terminate IQ traffic to the remote radio head (RRH). The power amplifiers (PAs) in the RRH will also be explicitly disabled in order to maximize the energy saving. However, shutting down a cell is complex and has an effect on neighboring cells.

The present disclosure describes an energy saving technique called energy saving layer shutdown (ESLS). Instead of shutting down the entire cell, we shut down one or more layers. The concept of layers is as follows. MNOs tend to deploy radios in RAN nodes in pairs or twins; one radio is directed to a lower frequency, such as Band 8, and one radio is used on a higher frequency (band 1, band 3, band 7 for 4G, N 78 for 5G). This is because lower frequencies have advantageous physical characteristics for propagation: specifically, they travel farther with less path loss and greater ability to traverse air and other physical barriers on their way to a UE. The higher frequencies have advantageous physical characteristics for data transmission capacity: greater bandwidth (B1 and B3 are capable of 20 MHz and n78 can do 100 MHz while B8 is limited to 10 MHz), which means greater data transmission capacity. The frequency bands commonly understood are listed in these references, hereby incorporated by reference: https://en.wikipedia.org/wiki/LTE_frequency_bands and https://en.wikipedia.org/wiki/5G_NR_frequency_bands. The lower frequency radio is called the coverage layer and the higher frequency is called the capacity layer.

As used herein, the term “coverage layer” refers to a radio frequency layer operating on a lower frequency band, such as Band 8 for 4G, which has advantageous physical characteristics for propagation including traveling farther with less path loss and greater ability to traverse air and other physical barriers. The term “capacity layer” refers to a radio frequency layer operating on a higher frequency band, such as Band 1, Band 3, or Band 7 for 4G, or N 78 for 5G, which has advantageous physical characteristics for data transmission capacity including greater bandwidth. Mobile network operators tend to deploy radios in RAN nodes in pairs or twins, with one radio directed to a lower frequency for coverage and one radio directed to a higher frequency for capacity.

As used herein, the term “vNode” refers to a virtualized node that performs baseband processing functions in a radio access network. A vNode may be implemented using virtualization technologies including one or more of containers, Kubernetes, Docker, hypervisors, virtual machines, hardware virtualization, microservices, or cloud computing platforms. In some embodiments, containerized microservices coordinated using Kubernetes are used to provide baseband processing for multiple RATs.

As used herein, the term “rApp” refers to an application that runs on a Non-RT RIC within a service management and orchestration (SMO) framework. An rApp may be configured by a network operator with one or more rules, such as specific numeric thresholds or time of day regimes, and may generate policies to be sent to a Near-RT RIC. The term “xApp” refers to an application that runs on a Near-RT RIC and performs near real time monitoring and control functions. An xApp may monitor parameters from across the RAN and may direct RAN nodes to perform operations such as layer shutdown or restoration.

As used herein, the term “IQ traffic” refers to in-phase and quadrature signal samples that are transmitted between a virtualized baseband unit and a remote radio head over a fronthaul interface. IQ samples represent the baseband representation of radio frequency signals and are used for digital signal processing in the baseband unit. When a cell is shut down, IQ traffic to the remote radio head is terminated, which contributes to energy savings.

As used herein, the term “Admin Down state” refers to an administrative state in which a cell's operation is suspended. When a cell is moved to Admin Down state, cell operation in the vNode is suspended, energy is saved in the virtualized baseband unit, and IQ traffic to the remote radio head is terminated. The Admin Down state is distinct from an operational failure state in that it is intentionally commanded by the network management system for purposes such as energy saving.

As used herein, the term “release command” refers to a command sent to a vNode that causes user equipment connected to a layer to be redirected to other cells. When a release command is sent, each UE that is connected to the layer is sent to other cells via a standard cell reselection procedure. The release command may be preceded by an instruction to the layer to ignore new attach requests, ensuring that no new UEs connect to the layer while existing UEs are being redirected.

As used herein, the term “administrative interface” refers to an interface through which management and control messages are exchanged between network elements. The administrative interface may be used to monitor the state of a vNode to ensure that it is verifiably turned off. An appropriate signal on the administrative interface indicating that a layer has been shut down may include a signal from an administrative layer at the node indicating that IQ sample processing has ceased at the radio.

As used herein, the term “service management and orchestration (SMO) node” refers to a node in the network core that performs management and orchestration functions for the radio access network. The SMO node may host a Non-RT RIC and one or more rApps. The SMO node may be configured by a network operator with rules and policies for network operation, including energy saving policies. The SMO node may communicate with a Near-RT RIC over an A1 interface to provide operational policies, and may place cells in inactive states for monitoring purposes.

Layer shutoff for energy saving in a radio access network requires coordination among three different layers of the cell stack: the RAN intelligent controller (RIC), which identifies low demand conditions and makes decisions about when to shut down or restore layers; the virtualized baseband unit (vBBU), which handles cell operational processing, including keeping the coverage layer alive while moving users off the capacity layer; and the remote radio head (RRH), where reducing power consumption greatly benefits from turning off power amplifiers. This multi-layer coordination enables energy savings while maintaining service continuity for users.

The RIC plays a central role in coordinating layer shutoff by monitoring activity measurements and making decisions based on predefined conditions. Within an O-RAN-based network architecture, the Near-RT RIC provides an ideal location from which to oversee energy saving operations. Via the E2 interface and the associated service models, it has near real time visibility of metrics from across the RAN, allowing it to formulate decisions based on multiple inputs and generate the associated RAN control signals. Additionally, the Near-RT RIC is connected to the Non-RT RIC over the A1 interface, from which it can be configured with operational policies. An rApp at a service management and orchestration (SMO) node in the network core may be configured by the network operator with one or more rules, for example specific numeric thresholds or time of day regimes. The rApp may take the rules and turn them into appropriate policies to be sent to the near-RT RIC via the A1 policy interface. The RIC may monitor the parameters and may direct the RAN nodes to perform layer shutdown.

The vBBU coordinates the operational aspects of layer shutoff to ensure service continuity. When a shutdown is commanded, the layer being shut down is first instructed to ignore new attach requests. A release command is then sent to the vNode for that layer, which results in each UE that is connected to the layer being sent to other cells via the standard cell reselection procedure. A subsequent check is performed to ensure that users have been moved to other cells. Shutting down the cell is realized by moving to Admin Down state which suspends the cell operation in the vNode, saving energy in the vBBU, and terminates IQ traffic to the remote radio head. The cell is then placed in an inactive state at the SMO, and monitoring continues for cell reactivation.

The RRH coordinates the physical radio aspects of layer shutoff to maximize energy savings. The power amplifiers in the RRH are explicitly disabled in order to maximize the energy saving when a layer is shut down. An administrative interface is monitored to ensure that the vNode handling the layer is verifiably turned off; an appropriate signal would be a signal from an administrative layer at the node indicating that IQ sample processing has ceased at the radio. When the capacity layer needs to be re-enabled based on activity measurements from the coverage layer rising above a threshold, the RRH power amplifiers are restored to active operation, and some UEs may be redirected to the newly activated capacity layer.

When under predefined load conditions, e.g., capacity load very low but coverage load very high, or e.g., capacity load high but coverage load low, we want to be able to turn off a layer to save power.

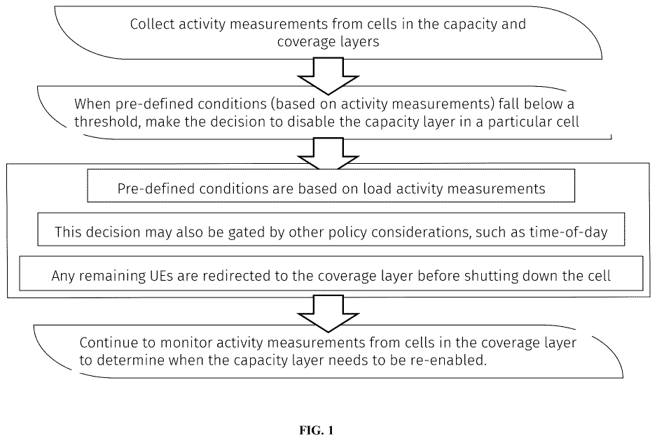

These are the steps for the control flow for layer shutdown, in some embodiments, as shown in FIG. 1:
1. Collect activity measurements from cells in the capacity and coverage layers
2. When pre-defined conditions (based on activity measurements) fall below a threshold, make the decision to disable the capacity layer in a particular cell
3. Pre-defined conditions are based on load activity measurements. This decision may also be gated by other policy considerations, such as time-of-day. Any remaining UEs are redirected to the coverage layer before shutting down the cell.
4. Continue to monitor activity measurements from cells in the coverage layer to determine when the capacity layer needs to be re-enabled.

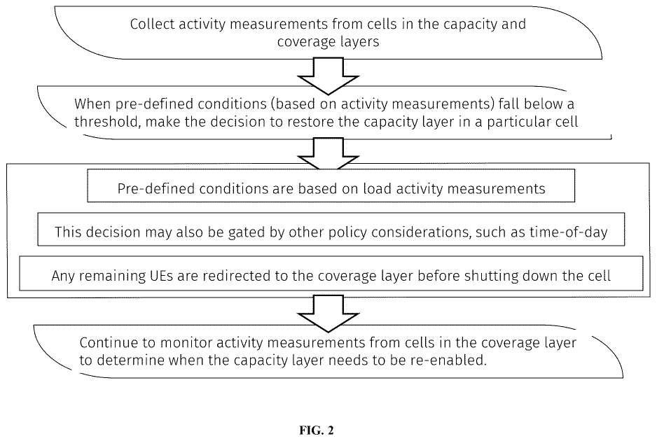

These are the steps for the control flow for layer re-enablement, in some embodiments, as shown in FIG. 2:
1. Collect activity measurements from cells in the capacity and coverage layers (in some cases only coverage layer will be active)
2. When pre-defined conditions (based on activity measurements) rise above a threshold, make the decision to enable or re-enable the capacity layer in a particular cell
3. Pre-defined conditions are based on load activity measurements. This decision may also be gated by other policy considerations, such as time-of-day. After enablement, some UEs shall be redirected to the newly activated capacity layer.
4. Continue to monitor activity measurements from cells in the coverage layer to determine if or when the capacity layer should to be shut down.

Time of day is relevant because traffic tends to follow certain historical patterns. For example, traffic tends to increase in commercial areas during the day and decrease at night, and conversely to decrease in residential areas during the day and increase at night. As well, traffic overall tends to decrease during the late night hours. These certain historical patterns that are known and programmed in by the network operator can be used to cause the system to use different thresholds during different time of day regimes, or, can be used to enable or disable the layer shutdown and reactivation detection system (the ESLS) entirely during certain time of day regimes.

The following considerations are considered for layer shutoff, in some embodiments.

Condition 1: users_cap<ESLS_thresh_quiet_user (the number of users in the capacity layer is less than a threshold for quiescent user conditions)

Condition 2: users_cvg+users_cap<ESLS_thresh_busy_user (the total number of users in both the coverage and capacity layers is less than a threshold for busy user conditions)

Condition 3: dl_prbs_util_cap<ESLS_thresh_quiet_dl (the downlink physical resource block (PRB) utilization in the capacity layer is less than a threshold for quiescent downlink conditions)

Condition 4: dl_prbs_util_cap*(Cap BW/Cvg BW)+dl_prbs_util_cvg<ESLS_thresh_busy_dl (the downlink PRB utilization in the capacity layer, normalized by the ratio of capacity bandwidth to coverage bandwidth, plus the downlink PRB utilization in the coverage layer is less than a threshold for busy downlink conditions)

Condition 5: ul_prbs_util_cap<ESLS_thresh_quiet_ul (the uplink PRB utilization in the capacity layer is less than a threshold for quiescent uplink conditions)

Condition 6: ul_prbs_util_cap*(Cap BW/Cvg BW)+ul_prbs_util_cvg<ESLS_thresh_busy_ul (the uplink PRB utilization in the capacity layer, normalized by the ratio of capacity bandwidth to coverage bandwidth, plus the uplink PRB utilization in the coverage layer is less than a threshold for busy uplink conditions)

In some embodiments all of conditions 1-6 must be met for a layer to be shut off. In some embodiments some combination of these conditions must be met for layer shutoff. In some embodiments a normalization factor of Cap BW/Cvg BW (the ratio of capacity bandwidth to coverage bandwidth) is used.

The following considerations are considered for layer restore, in some embodiments.

Condition 7: users_cvg>=ESLS_thresh_busy_user (the number of users in the coverage layer is greater than or equal to the threshold for busy user conditions)

Condition 8: dl_prbs_util_cvg>=ESLS_thresh_busy_dl (the downlink physical resource block (PRB) utilization in the coverage layer is greater than or equal to the threshold for busy downlink conditions)

Condition 9: ul_prbs_util_cvg>=ESLS_thresh_busy_ul (The uplink PRB utilization in the coverage layer is greater than or equal to the threshold for busy uplink conditions)

Only one of these conditions need to be true for a particular layer (either capacity or coverage) to be restored, in some embodiments. In other embodiments more than one of these conditions may be required to be true.

Regarding potential interactions between the capacity and coverage layers, we have analyzed the following scenarios. We take into account the load of the other twinned layer, because a shutdown will affect both; a shutdown of one layer that will result in the other layer becoming overloaded is not desirable. When turning a layer back on, we anticipate that load will be spread across both layers.

When a shutdown is commanded, the following steps are taken. First, the layer being shut down is instructed to ignore new attach requests. Second, a release command is sent to the vnode for that layer. This results in each UE that is connected to the layer being sent to other cells via the standard cell reselection procedure. Third, a subsequent check is performed to ensure that all users have been moved to other cells. Fourth, a cell shutdown message is sent via an administrative message. Fifth, an administrative interface is monitored to ensure that the vnode handling the layer is verifiably turned off; an appropriate signal would be a signal from an administrative layer at the node indicating that all I/Q sample processing has ceased at the radio. Sixth, the cell is placed in an inactive state at the SMO (monitoring node). Seventh, monitoring continues for cell reactivation.

Turning to the implementation of ESLS in an O-RAN compatible network architecture, configuration may be provided by a combination of an rApp at a service management and orchestration (SMO) node in the network core and an xApp at a near-Real Time RAN intelligent controller (RIC). The rApp may be configured by the network operator with one or more rules, for example specific numeric thresholds or time of day regimes as described above. The rApp may take the rules and turn them into appropriate policies to be sent to the near-RT RIC via the A1 policy interface. The scope of the A1 policy may be the target cell with the capacity layer required to be shut down. The RIC may monitor the parameters and may direct the RAN nodes to perform layer shutdown, in some embodiments. In some embodiments the RIC may be directly configured with the parameters. In some embodiments the individual processes performing monitoring may be accessed at the RIC administrative interface as individual xApps. In some embodiments ESLS may be used without an ORAN-compatible architecture, for example directly from an SMO or other management node in the core network, in some embodiments. ESLS is appropriate for use in both 4G and 5G, in some embodiments.

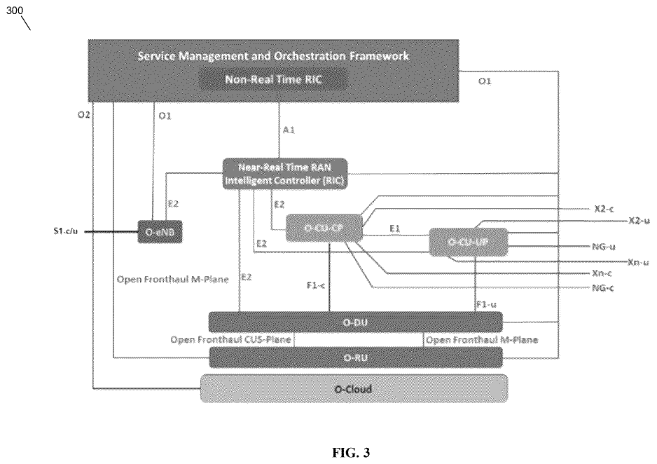

FIG. 3 is a schematic diagram of an Open RAN 4G/5G deployment architecture, as known in the prior art. The O-RAN deployment architecture includes an O-DU and O-RU, as described above with respect to FIG. 2, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination As well, a non-real time RAN intelligent controller is shown, receiving inputs from throughout the network and specifically from the near-RT RIC and performing service management and orchestration (SMO), in coordination with the operator's network (not shown). Absent from the ORAN network concept is any integration of 2G, 3G. Also absent is any integration of a 2G/3G/4G DU or RU.

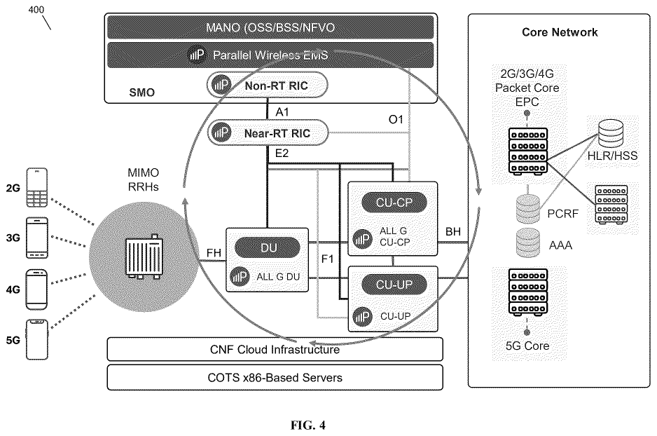

FIG. 4 is a third schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

In operation, for some embodiments, for example, when a coverage cell is heavily loaded, an rApp on the non-RT RIC and an xApp on the near-RT RIC coordinate to identify a mitigation, which can include identifying an appropriate capacity cell to activate; activating the cell; and handing over users from the coverage cell to the newly active cell. In another example, in some embodiments, in the case that admission control is identified as causing too many users to be admitted to the network at the same time, throttling may be performed. Monitoring of network load and a subsequent instruction to perform throttling may be initiated at the near-RT RIC using an xApp, in some embodiments. This may be a multi-RAT activity and this may involve monitoring of network load for a first RAT and an instruction to perform throttling for a second RAT, in some embodiments.

FIG. 1 is a logic flow diagram of layer shutdown, in accordance with some embodiments. The diagram illustrates a high level flow description showing the steps for determining when to disable a capacity layer. The pre-defined conditions for layer shutdown include: a first condition where the number of users in the capacity layer is less than a threshold for quiescent user conditions; a second condition where the total number of users in both the coverage and capacity layers is less than a threshold for busy user conditions; a third condition where the downlink physical resource block utilization in the capacity layer is less than a threshold for quiescent downlink conditions; a fourth condition where the downlink physical resource block utilization in the capacity layer, normalized by the ratio of capacity bandwidth to coverage bandwidth, plus the downlink physical resource block utilization in the coverage layer is less than a threshold for busy downlink conditions; a fifth condition where the uplink physical resource block utilization in the capacity layer is less than a threshold for quiescent uplink conditions; and a sixth condition where the uplink physical resource block utilization in the capacity layer, normalized by the ratio of capacity bandwidth to coverage bandwidth, plus the uplink physical resource block utilization in the coverage layer is less than a threshold for busy uplink conditions. Time of day may also be considered. All conditions need to be true for layer shutdown, in some embodiments; in other embodiments some combination of conditions are true for layer shutdown. The A1 policy scope is the target cell that hosts the capacity layer to be shut down. A hysteresis time such as 15 minutes can be used for reevaluation, or the xApp sampling time, typically 5 minutes in some embodiments, or some other similar amount of time.

FIG. 2 is a logic flow diagram of layer reactivation, in accordance with some embodiments. The pre-defined conditions for layer restore include: a seventh condition where the number of users in the coverage layer is greater than or equal to the threshold for busy user conditions; an eighth condition where the downlink physical resource block utilization in the coverage layer is greater than or equal to the threshold for busy downlink conditions; and a ninth condition where the uplink physical resource block utilization in the coverage layer is greater than or equal to the threshold for busy uplink conditions. At least one condition needs to be true for restoration.

MIMO channel configurations for energy savings, also referred to as energy saving MIMO option switch (ESMOS), may include changing the number of antennas and the number of layers. The number of transmit antennas and receive antennas may be independently configured, allowing for configurations such as 4T4R (four transmit, four receive), 2T 4R (two transmit, four receive), 2T2R (two transmit, two receive), or 1T 2R (one transmit, two receive). By reducing the number of active transmit streams, the associated power amplifiers may be disabled, resulting in energy savings. The number of MIMO layers corresponds to the number of independent data streams that can be transmitted simultaneously, and reducing the number of layers reduces the processing and power requirements while still maintaining connectivity for users with lower throughput demands.

The scope of energy saving functionality includes MIMO option switch at times of low demand in terms of cell load, with restoration when demand increases. Shutting down the antennas may be realized by moving to an inactive array carrier of the corresponding streams, including transmit and receive low-level-endpoints linked to the array carrier. The relevant power amplifiers in the RRH may be explicitly disabled in order to enable energy saving. When cell load increases or link quality metrics (e.g., SINR, error rate, cell reselection etc.) indicate that additional capacity is needed, the antenna configuration may be restored to its original state by re-enabling the inactive array carriers and associated power amplifiers.

In addition to layer shutdown, MIMO channel shutdown may be implemented using the same xApp and rApp architecture described above for energy saving layer shutdown. An xApp on the Near-RT RIC may optimize user equipment MIMO configuration, for example by switching between MIMO 4×4 and MIMO 2×2 configurations, while maintaining UE channel quality. Other MIMO configurations may also be used, including higher MIMO configurations such as MIMO 8×8, MIMO 16×16, MIMO 64×64, or other configurations, with the xApp switching between a higher configuration and a lower configuration based on demand. The MIMO channel shutdown xApp may monitor cell load conditions and link quality metrics to determine when to decrease the number of MIMO streams, thereby reducing the number of active antennas and associated power amplifier usage. Similar to layer shutdown, the MIMO channel shutdown may be configured by an rApp at the SMO node with thresholds and time-of-day policies, and the xApp may perform near real time monitoring and control to switch MIMO configurations based on demand. When cell load increases or link quality degrades, the xApp may restore the original MIMO configuration to maintain user experience. This approach allows operators to achieve additional energy savings at the cluster level by constraining the number of downlink MIMO layers during periods of low demand.

The following conditions may be considered for decreasing MIMO option switch, where several or all of these conditions may be required to be true. A first condition is where the number of connected users in the cell is less than a threshold for quiescent user conditions. A second condition is where the uplink physical resource block utilization in the cell is less than a threshold for quiescent uplink conditions. A third condition is where the uplink physical resource block utilization in the cell, multiplied by a receive antenna scaling factor, is less than a threshold for busy uplink conditions, where the receive antenna scaling factor is the ratio of the current receive antenna configuration to the target number of receive streams. A fourth condition is where the downlink physical resource block utilization in the cell is less than a threshold for quiescent downlink conditions. A fifth condition is where the estimated downlink physical resource block utilization after MIMO reconfiguration is less than a threshold for busy downlink conditions, where the estimated utilization accounts for the distribution of user equipment across different rank indicator values and normalizes the utilization based on the target number of transmit streams. A sixth condition is where the percentage of user equipment with low link quality in the uplink path is less than a threshold percentage for uplink low link conditions. A seventh condition is where the percentage of user equipment with low link quality in the downlink path is less than a threshold percentage for downlink low link conditions. Time of day may also be considered. In some embodiments, all of these conditions must be met for the MIMO configuration to be decreased. In some embodiments, some combination of these conditions must be met for the MIMO configuration to be decreased. In some embodiments, one or more of the following conditions should be met to cause MIMO option to be up-switched: an increase of a number of connected users above a threshold; a number of utilized PRBs, either UL or DL, above a threshold. The A1 policy scope is the target cell that hosts the MIMO configuration to be reduced. A hysteresis time such as 15 minutes can be used for reevaluation, or the xApp sampling time, typically 5 minutes in some embodiments, or some other similar amount of time.

While not shown, sequences for MIMO downselection and option switching are similar to those for layer shutdown as shown in FIGS. 1 and 2.

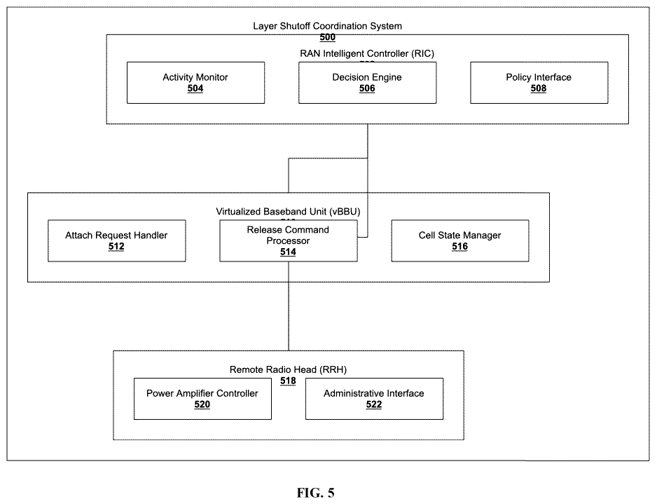

FIG. 5 illustrates a block diagram of a layer shutoff coordination system 500 for managing layers in a radio access network. The layer shutoff coordination system 500 includes three main components: a RAN Intelligent Controller (RIC) 502, a Virtualized Baseband Unit (vBBU) 510, and a Remote Radio Head (RRH) 518.

The RAN Intelligent Controller (RIC) 502 contains an Activity Monitor 504, a Decision Engine 506, and a Policy Interface 508. The Activity Monitor 504 collects activity measurements from cells in the capacity and coverage layers. The Decision Engine 506 determines when to disable or re-enable the capacity layer based on predefined conditions and the collected activity measurements. The Policy Interface 508 receives operational policies from a Non-RT RIC over an A1 interface and communicates with other network elements.

The Virtualized Baseband Unit (vBBU) 510 contains an Attach Request Handler 512, a Release Command Processor 514, and a Cell State Manager 516. The Attach Request Handler 512 instructs the capacity layer to ignore new attach requests when a shutdown is commanded. The Release Command Processor 514 sends release commands to redirect user equipment connected to the capacity layer to the coverage layer via standard cell reselection procedures. The Cell State Manager 516 manages the transition of cells to Admin Down state, which suspends cell operation and terminates IQ traffic to the remote radio head.

The Remote Radio Head (RRH) 518 contains a Power Amplifier Controller 520 and an Administrative Interface 522. The Power Amplifier Controller 520 disables power amplifiers associated with the capacity layer when the layer is shut down to maximize energy savings. The Administrative Interface 522 monitors the state of the vNode to ensure that the layer is verifiably turned off and provides signals indicating that IQ sample processing has ceased.

The RAN Intelligent Controller (RIC) 502 is connected to both the Virtualized Baseband Unit (vBBU) 510 and the Remote Radio Head (RRH) 518. The Virtualized Baseband Unit (vBBU) 510 is also connected to the Remote Radio Head (RRH) 518. These connections enable coordinated layer shutoff operations where the RAN Intelligent Controller (RIC) 502 identifies low demand conditions and makes decisions, the Virtualized Baseband Unit (vBBU) 510 handles cell operational processing and user redirection, and the Remote Radio Head (RRH) 518 manages power amplifier states to achieve energy savings while maintaining service continuity.

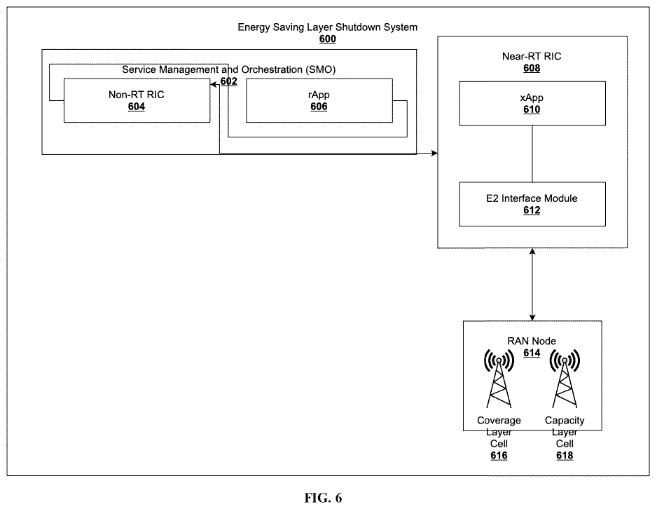

FIG. 6 illustrates a block diagram of an Energy Saving Layer Shutdown System 600. The Energy Saving Layer Shutdown System 600 includes a Service Management and Orchestration (SMO) 602, a Near-RT RIC 608, and a RAN Node 614. The Service Management and Orchestration (SMO) 602 contains a Non-RT RIC 604 and an rApp 606. The rApp 606 is connected to the Non-RT RIC 604. The Near-RT RIC 608 contains an xApp 610 and an E2 Interface Module 612. The xApp 610 is connected to the E2 Interface Module 612. The Non-RT RIC 604 is bidirectionally connected to the Near-RT RIC 608, enabling the exchange of operational policies. The Near-RT RIC 608 is bidirectionally connected to the RAN Node 614, allowing for near real time monitoring and control of RAN elements. The RAN Node 614 includes a Coverage Layer Cell 616 and a Capacity Layer Cell 618. The Coverage Layer Cell 616 operates on a lower frequency band with advantageous propagation characteristics, while the Capacity Layer Cell 618 operates on a higher frequency band with greater bandwidth for data transmission capacity. The rApp 606 may be configured by a network operator with rules such as specific numeric thresholds or time of day regimes, and generates policies to be sent to the Near-RT RIC 608. The xApp 610 performs near real time monitoring and control functions, monitoring parameters from across the RAN via the E2 Interface Module 612 and directing the RAN Node 614 to perform operations such as layer shutdown or restoration of the Capacity Layer Cell 618.

### Additional Embodiments

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

Where virtualization is described herein (“vNode”), one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality. Where the term “all-G” is used herein, it is understood to mean multi-RAT (having at least two radio access technologies).

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for managing layers in a radio access network, comprising:
collecting activity measurements from cells in a capacity layer and a coverage layer;
determining, by a RAN intelligent controller (RIC), to disable the capacity layer in a particular cell when predefined conditions based on the activity measurements fall below a threshold;
instructing, by a virtualized baseband unit (vBBU), the capacity layer to ignore new attach requests;
sending a release command to redirect user equipment (UE) connected to the capacity layer to the coverage layer;
disabling power amplifiers in a remote radio head (RRH) associated with the capacity layer; and
continuously monitoring activity measurements from the coverage layer to determine when the capacity layer needs to be re-enabled.

2. The method of claim 1, wherein the RIC receives operational policies from a Non-RT RIC over an A1 interface.

3. The method of claim 1, wherein the RIC has near real time visibility of metrics from across the RAN via an E2 interface.

4. The method of claim 1, wherein the predefined conditions include a condition where a number of users in the capacity layer is less than a threshold for quiescent user conditions.

5. The method of claim 1, wherein the predefined conditions include a condition where a downlink physical resource block utilization in the capacity layer is less than a threshold for quiescent downlink conditions.

6. The method of claim 1, wherein the predefined conditions include a condition where an uplink physical resource block utilization in the capacity layer is less than a threshold for quiescent uplink conditions.

7. The method of claim 1, wherein the determination to disable the capacity layer is gated by a time-of-day policy.

8. A system for managing layers in a radio access network, comprising:
a RAN intelligent controller (RIC) configured to collect activity measurements from cells in a capacity layer and a coverage layer and to determine to disable the capacity layer in a particular cell when predefined conditions based on the activity measurements fall below a threshold;
a virtualized baseband unit (vBBU) configured to instruct the capacity layer to ignore new attach requests and to send a release command to redirect user equipment (UE) connected to the capacity layer to the coverage layer; and
a remote radio head (RRH) configured to disable power amplifiers associated with the capacity layer when the capacity layer is shut down.

9. The system of claim 8, wherein the RIC is a Near-RT RIC connected to a Non-RT RIC over an A1 interface, from which the Near-RT RIC is configured with operational policies.

10. The system of claim 8, wherein the RIC is configured to monitor parameters via an E2 interface and to direct RAN nodes to perform layer shutdown.

11. The system of claim 8, wherein the RIC is configured to receive policies from an rApp at a service management and orchestration (SMO) node via an A1 policy interface.

12. The system of claim 8, wherein the vBBU is configured to move the cell to an Admin Down state which suspends cell operation in a vNode and terminates IQ traffic to the RRH.

13. The system of claim 8, wherein the vBBU is configured to perform a check to ensure that all users have been moved to other cells before shutting down the capacity layer.

14. The system of claim 8, wherein the RRH is configured to monitor an administrative interface to ensure that a vNode handling the capacity layer is verifiably turned off.

15. A non-transitory computer-readable medium storing instructions that, when executed by a processor, cause the processor to perform operations for managing layers in a radio access network, the operations comprising:
collecting activity measurements from cells in a capacity layer and a coverage layer;
determining to disable the capacity layer in a particular cell when predefined conditions based on the activity measurements fall below a threshold;
instructing the capacity layer to ignore new attach requests;
sending a release command to redirect user equipment (UE) connected to the capacity layer to the coverage layer;
disabling power amplifiers in a remote radio head (RRH) associated with the capacity layer; and
continuously monitoring activity measurements from the coverage layer to determine when the capacity layer needs to be re-enabled.

16. The non-transitory computer-readable medium of claim 15, wherein the operations further comprise receiving operational policies from a Non-RT RIC over an A1 interface.

17. The non-transitory computer-readable medium of claim 15, wherein the predefined conditions include a condition where a total number of users in both the coverage and capacity layers is less than a threshold for busy user conditions.

18. The non-transitory computer-readable medium of claim 15, wherein the operations further comprise re-enabling the capacity layer when activity measurements from the coverage layer rise above a threshold.

19. The non-transitory computer-readable medium of claim 15, wherein the operations further comprise restoring power amplifiers in the RRH to active operation when the capacity layer is re-enabled.

20. The non-transitory computer-readable medium of claim 15, wherein the operations further comprise redirecting some UEs to the capacity layer after the capacity layer is re-enabled.

21. A method for managing layers in a radio access network node, comprising:
collecting activity measurements from cells in both the capacity and coverage layers;
determining to disable the capacity layer in a particular cell when predefined conditions based on the activity measurements fall below a threshold;
redirecting any remaining user equipment (UE) to the coverage layer before shutting down the capacity layer in the cell; and
continuously monitoring activity measurements from cells in the coverage layer to determine when the capacity layer needs to be re-enabled.
